(19) United States
(12) Patent Application Publication
(10) Pub. No.: US 2007/0040645 A1
(43) Pub. Date: Feb. 22, 2007

(54) Transformer And Method Of Winding Same

(76) Inventors: Stephen Michael Sedio, Valley Center, CA (US); Kurt David Smith, McHenry, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/465,554

(22) Filed: Aug. 18, 2006

Related U.S. Application Data
(60) Provisional application No. 60/709,479, filed on Aug. 19, 2005.

(51) Int. Cl. H01F 27/28

(52) U.S. Cl. 336/232

(57) ABSTRACT

A component having a core, a first multi-wire bundle having primary and secondary windings wound about the core and a second multi-wire bundle having primary and secondary windings wound about the same core. In one form, the first and second bundles are wound in parallel with one another in a bifilar manner about the core. The method of winding the component allows the component to handle high current, high frequency data applications. An isolation transformer and filter circuit are also shown using the transformer and/or method of winding same.

### CROSS-REFERENCE TO RELATED APPLICATION

This application claims the benefit of U.S. Provisional Application No. 60/709,479, filed Aug. 19, 2005, which is hereby incorporated herein by reference in its entirety.

### TECHNICAL FIELD

The present invention relates to magnetic components, and more particularly, a transformer and method of winding the same that improves the manufacturability and performance of the components during high power, high frequency and/or high data rate applications.

### BACKGROUND OF THE INVENTION

A typical transformer includes two or more coupled electrical conductors or windings, often referred to as the primary and the secondary windings, and in most cases includes a magnetic core to concentrate magnetic flux. Current in one winding creates a time-varying magnetic flux in the core, which induces a voltage in the other winding. Thus, the transformer transfers energy from one circuit to another and can be used to convert between high and low voltages, to change impedence and to provide electrical isolation between the circuits.

In networking applications, such as Ethernet applications, a primary set of wires typically transmits data from a first device to a second and a secondary set of wires transmits data from the second device to the first. Some Ethernet applications use a number of transformers (e.g., center tapped transformers, autotransformers, etc.) and/or common mode chokes to transfer data between the two devices. In addition, newer devices use Ethernet magnetics to transfer electrical power, i.e., Power over Ethernet (“PoE”) technology. PoE devices transmit power, along with data, to remote devices over standard twisted-pair cable(s) in an Ethernet network. Local-area network (LAN) access points, webcams, Ethernet hubs, computers, are just a few of the devices that employ PoE technology. For this reason, PoE magnetic components must be designed to handle the data and power transferred.

Conventional networking hardware, such as Ethernet cards, have been designed with electronic components and circuitry capable of handling data transfer for many years. One problem with existing networking hardware, and their electronic components and circuitry, however, is that they are incapable of being used in many high power/high frequency data transfer applications, such as for example handling high power gigabit data signals and/or PoE applications. For example, most conventional transformers would result in data loss at such high power/high frequencies because the power will saturate the core.

Although some conventional high power transformers are capable of handling the power levels for these applications, these transformers are not capable of handling the high frequency data rate associated with such data signals. Conversely, there are some broadband transformers that are capable of handling the high frequency data rate associated with such signals, but these transformers are not capable of handling the power levels associated with such signals.

Accordingly, it has been determined that the need exists for an improved transformer which overcomes the aforementioned limitations and which further provides capabilities, features and functions, not available in current devices and for a method of winding a transformer to accomplish the same.

### BRIEF DESCRIPTION OF THE DRAWINGS

FIG. 1A is a side elevational view of a core illustrating a manner in which the two 4-wire bundles may be wound in accordance with the invention;

FIG. 1B is another side elevational view of the core of FIG. 1A illustrating a manner in which the wire ends of the two 4-wire bundles may be connected with one another in accordance with the invention;

FIG. 1C is another side elevational view of the core of FIGS. 1A-B illustrating a manner in which the interconnected wire ends or leads of the two 4-wire bundles may be laced or connected into an SMD module or package;

FIG. 2A is a plan view of an isolation transformer module in accordance with the invention;

FIG. 2B is a side elevational view of the isolation transformer module of FIG. 2A;

FIG. 2C is a bottom view of the isolation transformer module of FIG. 2A;

FIG. 2D is a cross sectional view of the isolation transformer module of FIG. 2A taken along line 2D-2D;

FIG. 2E is an enlarged view of the isolation transformer module of FIG. 2C illustrating how the two transformers may be wound in accordance with the invention;

FIG. 3 is a schematic diagram of an isolation transformer package in accordance with the invention;

FIG. 4 is a schematic diagram of a filter circuit in accordance with the invention; and

FIG. 5 is a wiring diagram of the filter circuit of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DESCRIPTION OF THE PREFERRED EMBODIMENTS

A transformer and method of winding same in accordance with the invention includes a plurality of primary and secondary windings that are wound in parallel upon the same core, such that the transformer is capable of handling high current, high frequency data applications. The transformer and method including windings of multi-wire bundles (or multi-filer windings) of both primary and secondary windings in parallel to reduce the amount of leakage inductance such that the component is capable of handling high frequency data transmission in addition to high current applications.

In the embodiments illustrated, the transformer has a first four wire bundle (or quadfilar winding) comprising the top and bottom half of the primary of the isolation transformer and the top and bottom half of the secondary of the isolation transformer, and a second quadfilar winding wound in parallel with the first four wire bundle that includes parallel top and bottom halves of the primary of the isolation transformer and parallel top and bottom halves of the secondary of the isolation transformer. The quadfilar winding is twisted to the number of twists per inch to give an ideal transmission line like conventional transformer windings, however, unlike conventional transformer windings, the quadfilar windings include both primary and secondary windings. Thus, with this configuration a preferable balance is capable of being achieved between the top and bottom of each side of the primary and secondary portions of the transformer, thereby making the center tap of the isolation transformer as perfectly centered as possible.

The two quadfilar windings are then wound in a bifilar manner about the same core in order to obtain a preferable coupling which in turn reduces the leakage inductance of the transformer between twenty-five to fifty percent (25%-50%), depending on the actual bundle coupling. With such a winding configuration, the transformer effectively comprises two transformers wound in parallel on the same core that together operate as a single transformer capable of handling high current and high frequency data applications. As such, the following description will interchange between the literal reference to a transformer having two bundles of primary and secondary windings wound in parallel about a single core and the effectively equivalent reference to a transformer having two transformers wound in parallel about the same core.

Having multiple transformers wound on one core does not affect the low frequency performance of the transformer because the excitation inductance is constant or unchanged. In other words, by putting the bundles on one core the inductance will remain the same and, thus, preserve the low frequency performance of the transformer. Further, the multiple wire bundles of primary and secondary windings (or multiple transformers) wound in parallel lowers the leakage inductance that would be achieve with a single winding.

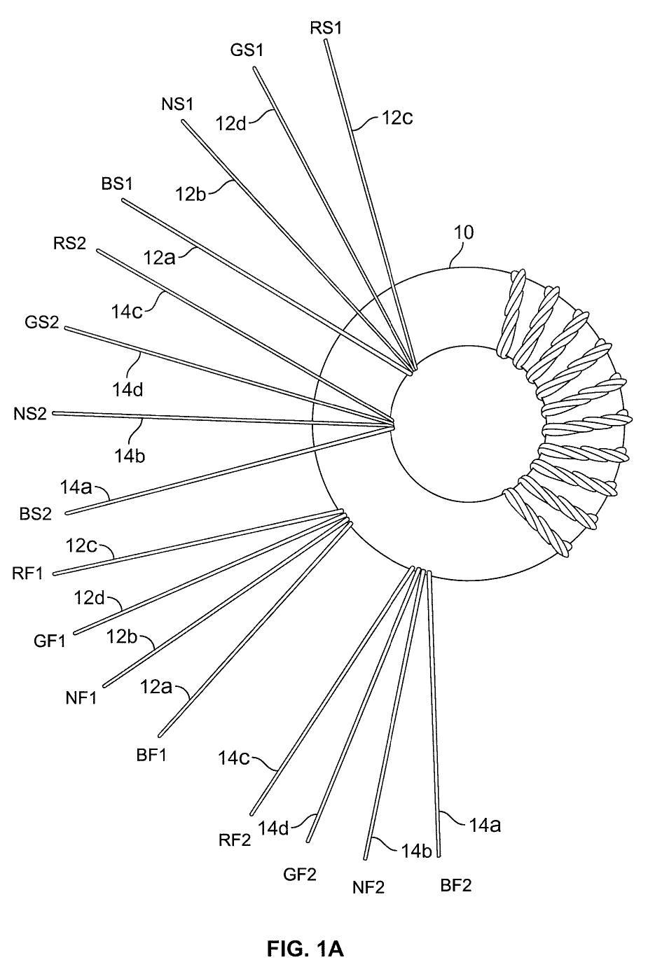

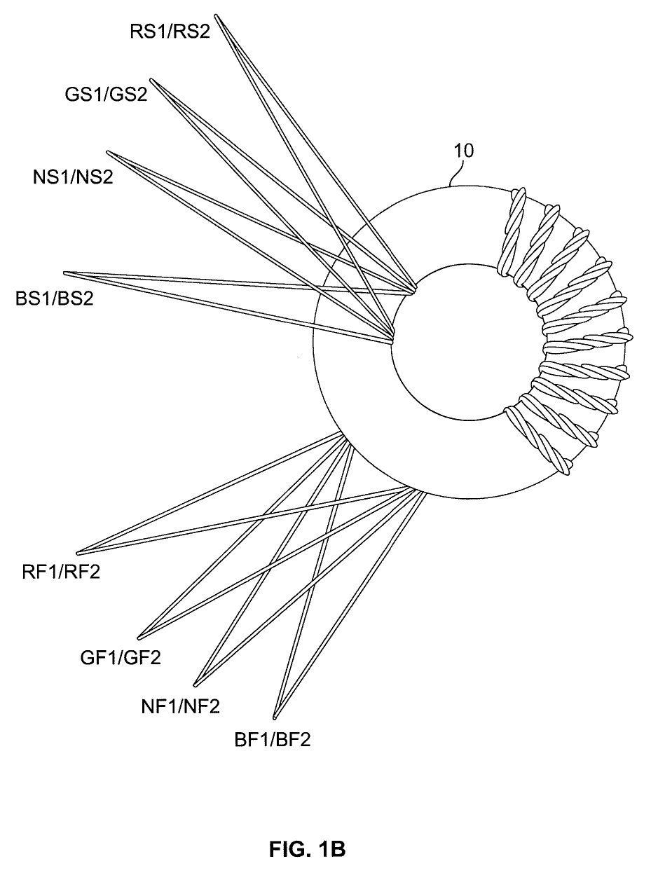

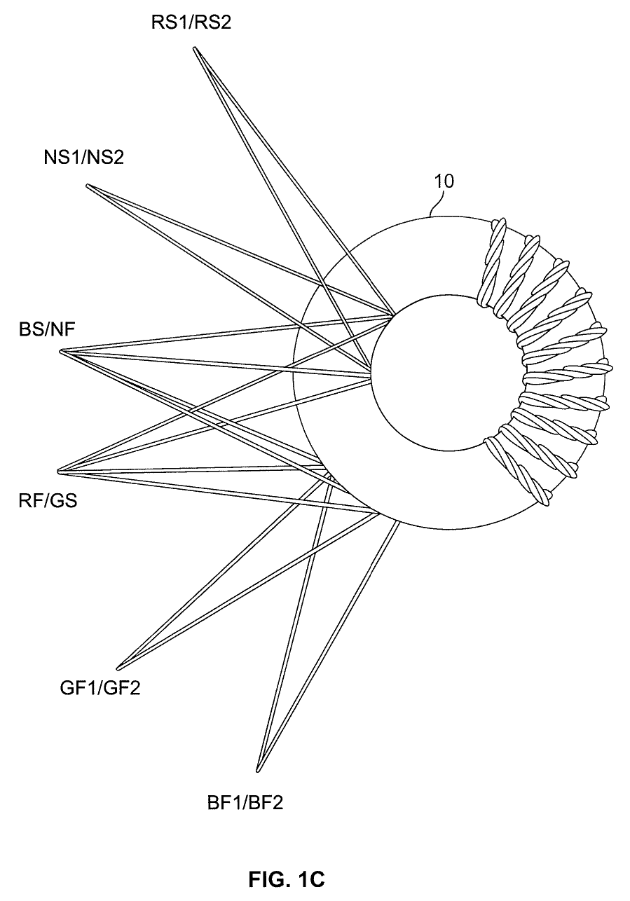

Turning now to FIGS. 1A-C, there is illustrated a unique winding or winding pattern that allows a transformer to handle high power/high frequency data signals. In a preferred form, the primary and secondary of the transformer core are wound at the same time with two 4-wire bundles (e.g., four wires twisted together). By winding the primary and secondary of the transformer with two 4-wire bundles, the transformer is, in effect, being wound with a bifilar winding, which is a winding of two insulated conductors (in this case two 4-wire bundles) wound side-by-side to produce a balanced winding with maximum coupling (e.g., close and even coupling) between the two windings.

In the embodiment illustrated, the first 4-wire bundle 12 is made up of four insulated copper wires, 12a-d, and the second 4-wire bundle 14 is made up of four insulated copper wires, 14a-d. In a preferred form, each individual wire that makes up a 4-wire bundle is between a twenty gauge (20 AWG) wire and a forty-five gauge (45 AWG) wire. Each individual wire includes insulation that is of a different color or shade than the other individual wires. For example, in the form illustrated the first 4-wire bundle 12 is made up of a blue wire 12a, a clear (or natural) wire 12b, a red wire 12c and a green wire 12d. Similarly, the second 4-wire bundle 14 is made up of a blue wire 14a, a clear (or natural) wire 14b, a red wire 14c and a green wire 14d. It should be understood, however, that any conductive material may be used for the wire and that the wire size may be selected from a variety of wire gauges. For example, in an alternate 4-wire bundle, the individual wires may be of a gauge ranging between thirty-two gauge wire and forty-eight gauge wire (32-48 AWG), while in still other 4-wire bundles the individual wires may be of other wire gauges. It should also be understood that any color, shade of color or marking on the wire insulation may be used so long as the individual wires of a 4-wire bundle are capable of being distinguished from one another. In further embodiments, all the wires may have the same color insulation, if so desired.

Once the first and second wire bundles 12 and 14 are twisted together, the bundles 12 and 14 are wound bifilar about the core of a transformer. In a preferred form, the bundles 12 and 14 are wound in bifilar turns on a toroid core, such as core 10 illustrated in FIGS. 1A-C. The individual wires of the start and finish ends (or leads) of each bundle are then preferably untwisted and undressed or stripped back to the core so that like colored starts and like color finishes may be connected to one another. For example, in a preferred form, the start and finish ends or leads of the wire bundles 12 and 14 are stripped and connected in the following manner:
1. The two blue start ends of wires 12a and 14a (BS1/BS2) and the two clear (or neutral) finish ends of wires 12b and 14b are connected to one another;
2. The two blue finish ends of wires 12a and 14a (BF1/BF2) are connected to one another;
3. The two clear start ends of wires 12a and 14a (NS1/NS1) are connected to one another;
4. The two red start ends of wires 12a and 14a (RS1/RS2) are connected to one another;
5. The two green finish ends of wires 12a and 14a (GF1/GF2) are connected to one another; and
6. The two green start ends of wires 12a and 14a (GS1/GS2) and two red finish ends of wires 12a and 14a (RF1/RF2) are connected to one another.
   After the leads of the wires are connected in the manner discussed above, the stripped wire ends are soldered to ensure that the appropriate wires are electrically interconnected.

The wound core may then be wired to the transformer terminals to provide a transformer that is capable of handling high power/high frequency data signals, such as high power gigabit data signals. For example, in the transformer disclosed herein and wound in accordance with the invention, the transformer may handle power applications above thirty Watts (30 W) and preferably can handle between thirteen and fifty Watts (13-50 W) of power. To put this in perspective, conventional transformers for networking applications are currently only capable of handling up to about thirteen Watts (13 W) of power, which is insufficient for handling high power/high frequency data signals. In addition, the transformers disclosed herein and wound in accordance with the invention are capable of reaching a frequency response of about 100 MHz, whereas conventional power transformers can only reach a frequency response of about 30 MHz. Thus, by using the transformer or method of winding disclosed herein, a component can be manufactured using a larger core that is capable of handling a higher DC offset current (which would normally cause leakage inductance to increase) without causing the leakage inductance to increase (or effectively reducing the leakage inductance back down to what a smaller core would produce).

Although the components illustrated herein are of specific sizes and are surface mount devices (“SMD”), it should be understood that the described wiring pattern may be used in transformers of all sizes and shapes, including through-hole components. Similarly, although specific power levels or ranges and/or current and frequency ranges are provided, it should be understood that the transformer and method of winding same disclosed herein improves the performance of the transformer regardless of the power range and/or current and frequency ranges within which the transformer is used. For example, in alternate applications two of the transformers disclosed herein may be connected in parallel in order to provide a component capable of operating up to one hundred Watts (100 W). In yet other embodiments, the two pair configuration used with conventional category 5 cables for 10/100 Ethernet applications, may be replaced with a four pair configuration used with an RJ45 cable for Gigabit Ethernet applications (or possibly a new category 6 cable meant for such applications).

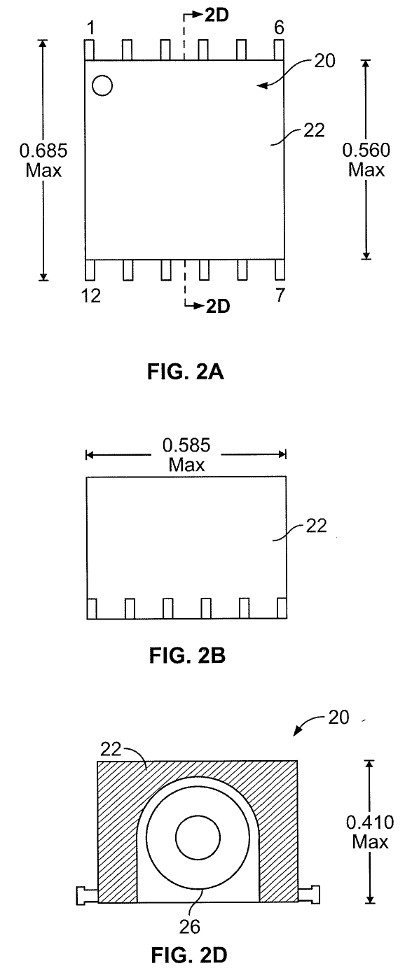

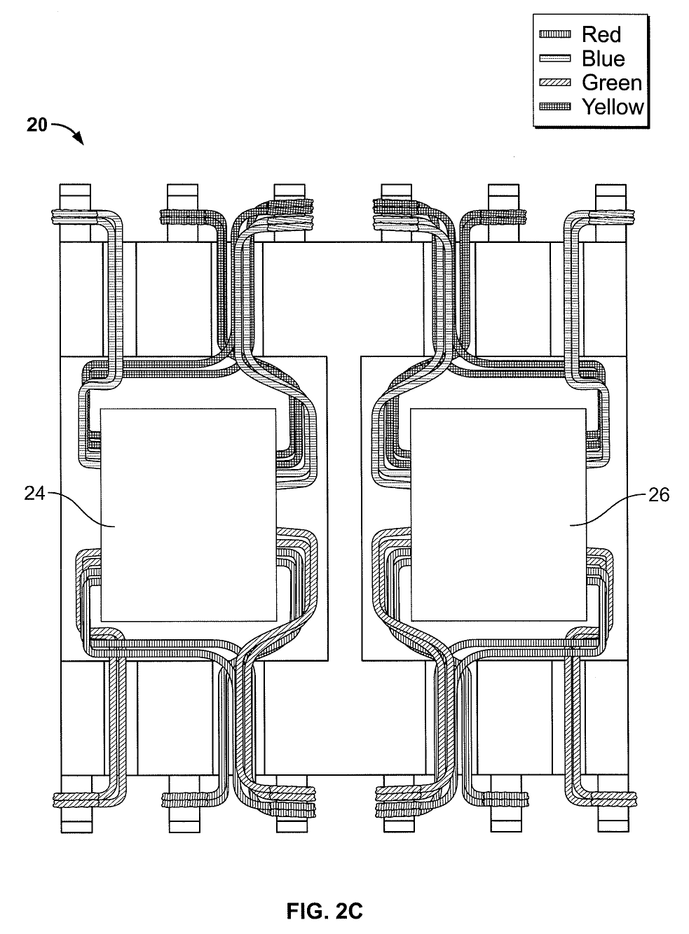

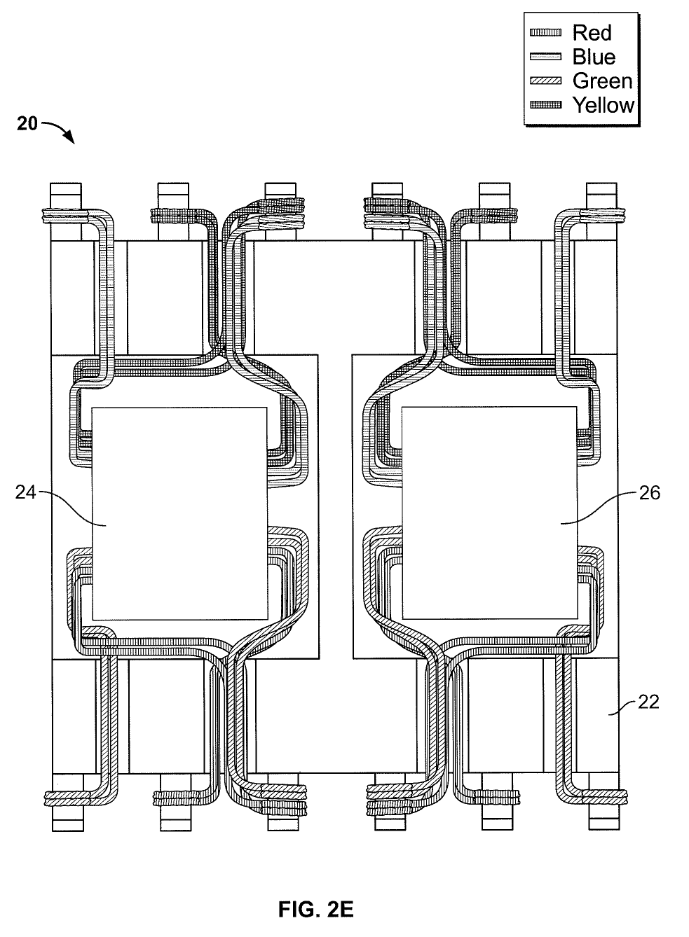

Turning now to FIGS. 2A-E, there is illustrated an isolation transformer module in accordance with the invention. The module is referred to generally herein by reference numeral 20 and includes a housing or package 22 which defines an opening for receiving one or more transformers wound in accordance with the wiring pattern discussed above. In the form illustrated, the module 22 has a first transformer 24 and a second transformer 26 disposed therein. In alternate embodiments, the isolation transformer 20 may be provided with a single transformer or with three or more transformers if desired.

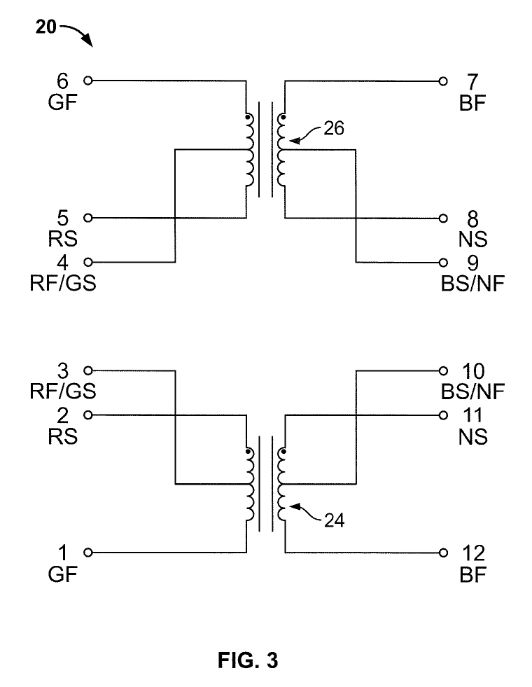

In FIGS. 2A-E, the first and second transformers, 24 and 26 respectively, are glued into the housing 22 and the stripped ends of the wires are laced or wrapped about winding posts extending from the housing 22. In a preferred form, the wire wrapped posts will be soldered in order to further ensure that an electrically sound terminal extends from the module 20. In alternate embodiments, however, the wire ends may be connected to terminals of the housing 22 in any conventional manner known in the industry, such as by metallization or welding, or with the use of clips, and in some instances the wire ends themselves may form the terminals. The housing 22 also will preferably provide a generally flat upper surface so that the module 20 may be picked up and placed onto a substrate, such as a printed circuit board, using conventional pick-and-place equipment. One example of how the module 20 may be configured in module 20 is illustrated in FIG. 3. For example, the terminals for the first transformer 24 may be connected to pins 1, 2, 3, 10, 11 and 12 of the module 20 and the terminals of the second transformer 26 may be connected to pins 4, 5, 6, 7, 8 and 9 of the module 20. It should be understood, however, that this schematic merely provides one example of how the transformers 24 and 26 may be connected in module 20.

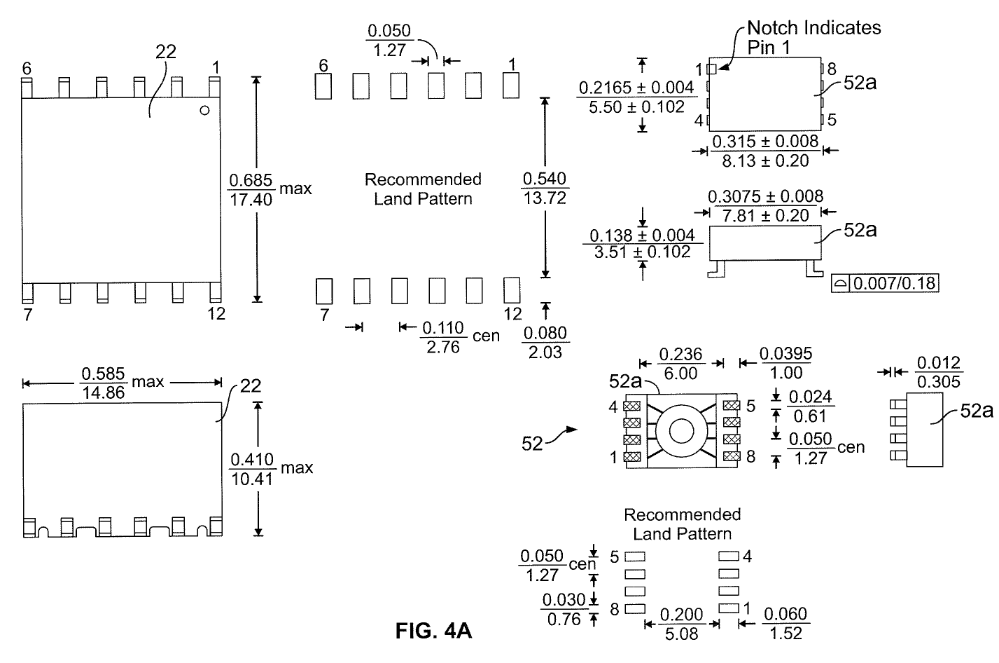

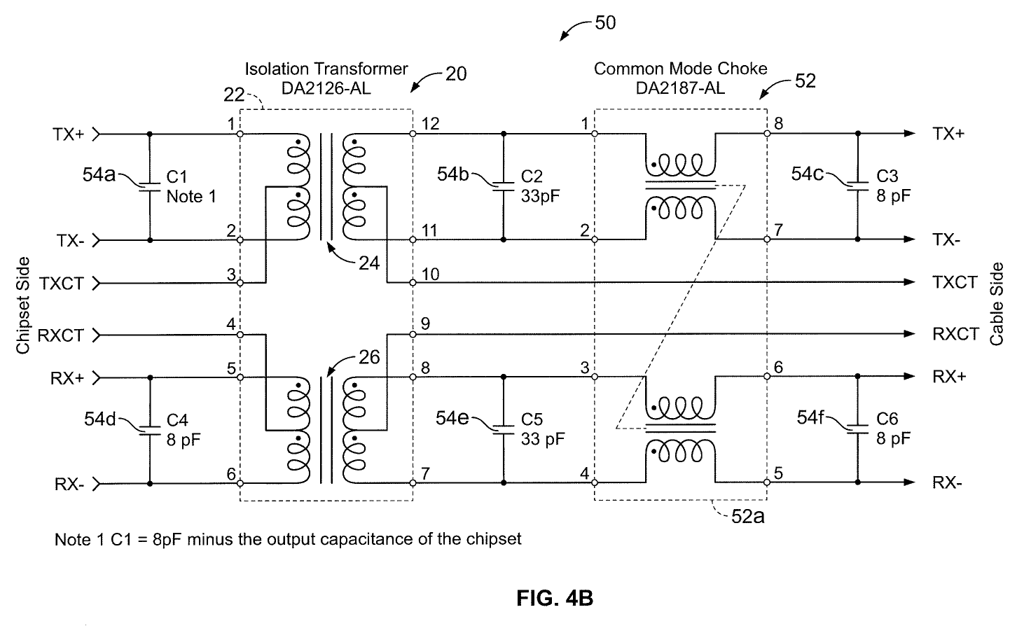

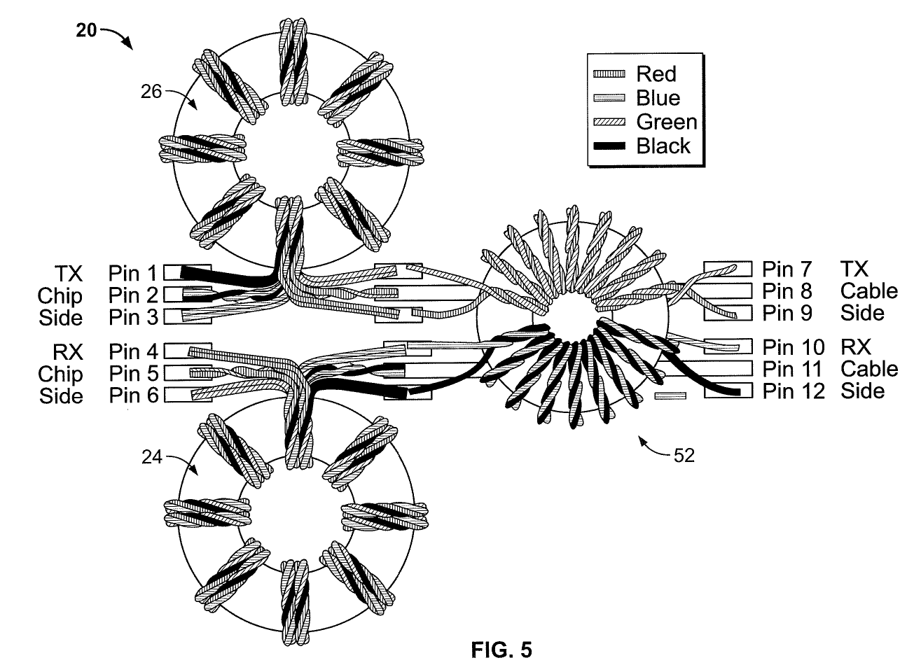

Turning now to FIG. 4, there is illustrated a filter circuit in accordance with the invention. The filter circuit 50, may include an isolation transformer, such as module 20 above, a choke 52, and a plurality of discrete components, such as capacitors 54a-f, for filtering out unwanted parasitic capacitance in a circuit. FIG. 4 also illustrates preferred embodiments of module 20 and a module 52a for choke 52. Modules 20 and 52a maybe wired in a variety of configurations, such as for example, in the configuration illustrated in FIG. 5. Although additional capacitors are needed to make the filter 50 behave like a five-pole filter, the added capacitors give the designer greater flexibility to customize the component and/or adjust the filter in order to get it to operate as desired. For example, the value of the additional capacitors can be more easily adjusted than the parasitic capacitance value created with conventional winding methods.

In Ethernet card and/or PoE applications, the networking magnetics disclosed herein will likely be provided on the Ethernet card itself rather than in the Ethernet connector or jack as is currently done, due to the size of the magnetic components and the power levels that the equipment may be setup to handle. It should be understood, however, that in alternate embodiments the Ethernet connector or jack could be made large enough to allow the magnetics discussed herein to be connected to the connector or jack, if so desired. In yet other embodiments, the networking magnetics disclosed herein may alternately be integrated into the cable that connects to the Ethernet connector/jack, if so desired.

The transformers configured according to the invention disclosed herein have high power, high frequency and high data rate capacities. For example, transformer 20 is capable of handling Direct Current (“DC”) offset currents over 20 mA, and in one preferred embodiment, the parallel wound transformer is capable of handling 22 mA or larger DC offset currents.

Paralleling the two or more bundles of primary and secondary windings (or transformers) provides a lower leakage inductance than could be achieved with a single winding thereby allowing the component to meet or exceed the Gigabit Ethernet standard of less than 10 dB of return loss from 100 kHz to 100 MHz for Gigabit applications. In addition, as mentioned above, winding the two or more bundles of primary and secondary windings (or transformers) on one core preserves the component's ability to be used in lower frequency applications, such as for example 10 MB/100 MB Ethernet applications.

Since each of the parallel wound bundles or transformers has a primary inductance and a leakage inductance, paralleling the bundles or transformers reduces the leakage inductances and eliminates the effect of the primary inductances, thereby increasing the frequency range over which the component may be used. This winding technique further allows the large core of the transformer 20, which would normally not be able to handle the high frequency/data rates, to handle the frequencies and data rates associated with Gigabit applications. For example, in one embodiment, transformer 20 is capable of operating at 350 μH of inductance at 85° C. when dealing with 22.5 mA or higher of DC offset current, without unnecessarily increasing the footprint of the component due to its ability to apply the unique winding pattern discussed herein on a conventional core.

Thus, in accordance with the present invention, a transformer, method of winding a transformer, transformer module and filter circuit are provided that fully satisfy the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A transformer comprising:
a core;
a first bundle of wires comprising primary and secondary windings; and
a second bundle of wires comprising primary and secondary windings wound in parallel with the first bundle of wires to form a transformer capable of handling high current and high frequency data applications.

2. The transformer of claim 1, wherein the first and second bundles each comprise four wire windings wound in a quadfilar manner.

3. The transformer of claim 2, wherein the first and second bundles are wound in a bifilar manner.

4. The transformer of claim 3, wherein the core is a toroid made of ferromagnetic material.

5. A transformer comprising:
a core; and
a plurality of multi-wire bundles having primary and secondary windings wound in parallel about said core.

6. The transformer of claim 5, wherein the plurality of multi-wire bundles are wound in a multi-filar manner to maximize coupling therebetween.

7. The transformer of claim 6, wherein the multi-wire bundles comprise first and second four-wire bundles, with each four-wire bundle being wound in a quadfilar manner and the first and second bundles being wound in a bifilar manner.

8. A method of assembling a transformer, comprising:
winding a first multi-wire bundle having primary and secondary windings about a core; and
winding a second multi-wire bundle having primary and secondary windings in parallel with the first multi-wire bundle and about said core.

9. The method of claim 8, wherein winding the first and second multi-wire bundles each comprise a four-wire winding wound in a quadfilar manner.

10. The method of claim 9, wherein the first and second multi-wire bundles are wound around said core in a bifilar manner.

11. A transformer module, comprising:
a core;
a first multi-wire bundle having primary and secondary windings wound about said core;
a second multi-wire bundle having primary and secondary windings wound about said core and in parallel with the first multi-wire bundle; and
a top covering at least a portion of the module and having a generally flat upper surface with which the module may be picked-up and placed on a substrate.

12. The transformer module of claim 11, wherein the individual multi-wire bundles are wound in a quadfilar manner and the first and second bundles are wound in a bifilar manner about said core.

13. A filter circuit, comprising:
a first transformer module having multi-wire bundles wound in parallel about a core;
a second transformer module having multi-wire bundles wound in parallel about a second core and electrically connected to the first transformer;
a choke electrically connected to the first and second transformer modules to form an electronic assembly; and
a plurality of discrete components electrically connected to the electronic assembly to filter a circuit.

14. The filter of claim 13 wherein the discrete components are capacitors.
